(19) United States
(12) Patent Application Publication
(10) Pub. No.: US 2022/0339647 A1
(43) Pub. Date: Oct. 27, 2022

(54) SPRAY MIST ASSIST SYSTEM FOR A LIQUID PUMP SPRAYER

(71) Applicant: THE FOUNTAINHEAD GROUP, INC., New York Mills, NY (US)

(72) Inventor: Justin Deschamps, Boonville, NY (US)

(73) Assignee: THE FOUNTAINHEAD GROUP, INC., New York Mills, NY (US)

(21) Appl. No.: 17/726,118

(22) Filed: Apr. 21, 2022

Related U.S. Application Data
(60) Provisional application No. 63/177,564, filed on Apr. 21, 2021.

(51) Int. Cl. B05B 7/08

(52) U.S. Cl. CPC B05B 7/0807; B05B 7/2402

(57) ABSTRACT

A spray mist assist assembly for a liquid sprayer utilizes an auxiliary blower positioned below the sprayer's nozzle. The positioning of the blower in vertical alignment with but in vertically spaced relation below the nozzle permits the mist expelled from the nozzle to extend farther from the sprayer to enhance the performance of the sprayer.

### CROSS-REFERENCE TO RELATED APPLICATION

The present application relates and claims priority to U.S. Provisional Patent Application Ser. No. 63/177,564 filed Apr. 21, 2021, the entirety of which is hereby incorporated by reference.

### FIELD OF THE INVENTION

The present disclosure is directed generally to a spray mist assist system for a liquid pump sprayer.

### BACKGROUND

Many convenient and relatively inexpensive cordless home lawn and garden sprayers are designed to be held and operated with one hand. As shown in FIG. 1, the liquid to be sprayed is contained in a bottle that is coupled to a housing assembly comprised of the batteries, electric motor, and liquid pump. A handle grip, incorporating a power switch, is integral to the housing. The nozzle is typically adjustable, enabling the spray output to vary between fine mist and coarse stream settings.

This format of handheld sprayer relies exclusively on the pressure supplied by the liquid pump to produce an intended effective spray mist application distance. It is understood that the greater the liquid pressure provided by the pump, the farther will be the resulting spray mist distance. For home lawn and garden sprayers, especially for applying a fine mist spray for outdoor mosquito control, the overall spray distance is an important aspect: an effective application distance enables the operator to safely and efficiently penetrate into and around the foliage where mosquitos reside.

FIG. 2 illustrates the relative functional impact of pump pressure on the effective spray mist application distance. Here, the effective spray distance for a mist application is represented as the length of an expanding conical spray pattern. As is well understood, Sprayer 1 with a 20 psi liquid pump produces an effective spray distance D1 that is less than the spray distance D2 produced by Sprayer 2 with a 40 psi pump. It should also be noted that Sprayer 2 would be more expensive to produce than Pump 1.

An equally important capability for the sprayer is the focused control of the spray mist pattern, along and to the extent of the intended effective mist distance. For both sprayers shown in FIG. 2, the effect of gravity causes the mist pattern to dissipate and lose focus — described herein as pattern dispersion or “fallout”. This fallout results in a loss of application efficiency; in this example of misting for mosquito control, the mist fallout pattern schematically characterizes the proportional distribution and volume of the insecticide that, due to gravity, falls short and does not reach the intended effective mist distance to the target foliage.

With attempts to optimize the effective mist distance for a given liquid pump sprayer, a conventional auxiliary air “blower” fan is often employed.

Referring to FIG. 3, a prior art liquid pump sprayer, Sprayer 3, is shown that employs an axial air fan blower (note A) in order to beneficially reach the intended spray distance for misting. Note that Air Outlet Nozzle (note B) centralizes the airstream flow path (note C) around the liquid outlet spray nozzle (note D). For such sprayers that employ an auxiliary fan, the sprayer would resultantly be more expensive, and the pump would be correspondingly specified to produce an appropriate liquid pressure. This exemplar sprayer otherwise comprises the same basic componentry of those less expensive liquid pump sprayers without an auxiliary fan, as previously described and illustrated.

The liquid pump pressure of Sprayer 3, in combination with the auxiliary axial fan air blower, does expectedly produce an intended spray mist distance, D3, that is proportionately greater than the previously described pumps. However, as shown in FIG. 4, fallout for this sprayer is still exhibited, especially when misting.

FIGS. 5A and 5B illustrate an alternative configuration of a prior art liquid pump sprayer, Sprayer 4, that employs an auxiliary fan in order to achieve an intended effective spray distance for misting. In this configuration, a radial fan (note E) produces the horizontal airstream (note F) positioned, via the Air Outlet Nozzle (note G), above a vertically-oriented liquid spray outlet nozzle (note H). In this configuration, as shown in FIGS. 6A and 6B, the horizontally-directed airstream is employed to intersect with and shear the vertically-oriented liquid spray, then propel the liquid spray outward in the direction of the airstream.

FIGS. 6A and 6B illustrate how the horizontally-directed airstream flow path (note I) is employed to intersect with and shear the vertically-oriented liquid spray, then propel the resulting liquid spray mist outward in the direction of the airstream (note J).

The radial fan produces a horizontally-oriented airstream directed against the vertically-oriented liquid spray with enough power to redirect and propel the liquid spray outward in the direction of the airstream. The sprayer's ability to reach the intended effective mist distance D4 requires the energy of the airstream itself. As shown in FIG. 7, mist fallout for this sprayer is still exhibited.

FIG. 8 provides a summary of these exemplar prior art sprayer configurations and example relative intended effective mist distances. Note that the mist fallout pattern also can vary, depending upon the sprayer characteristics. Indicated for each mist fallout pattern is the ineffective mist: that proportion of the mist that, due to gravity, falls short and does not reach the target.

For cordless home lawn and garden sprayers that employ a high pressure liquid pump, operating in combination with an auxiliary blower-type air fan to provide for an intended effective spray distance when spray misting for mosquito control, there exists a need in the art to minimize the fallout of spray mist, so a greater proportion of the insecticide efficiently reaches the intended spray distance.

### SUMMARY

The present disclosure is directed to a spray mist assist system for a liquid pump sprayer.

According to an aspect is a sprayer for spraying a liquid, comprising: a nozzle through which the liquid can be expelled in a first direction away from the sprayer; a fan positioned in vertical alignment with and axially below the nozzle and for generating an air flow in a second direction that is parallel to the first direction; and a fan outlet positioned in the path of the air flow and from which the air is expelled away from the sprayer.

According to an embodiment, the fan outlet is selectively pivotal about the second direction to selectively adjust the direction of the expelled air flow towards or away from the first direction.

According to an aspect is a sprayer for spraying a liquid, comprising a sprayer housing; a nozzle connected to the sprayer housing and through which the liquid can be expelled in a first direction away from the sprayer; a fan positioned within the sprayer housing and including a fan outlet that extends outside the sprayer housing and is positioned in axially spaced relation below the nozzle; and wherein the fan is mounted within the sprayer housing for selective pivotal movement that causes movement of the fan outlet towards or away from the nozzle.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIGS. 1A and 1B are illustrating two prior art cordless home lawn and garden sprayers.

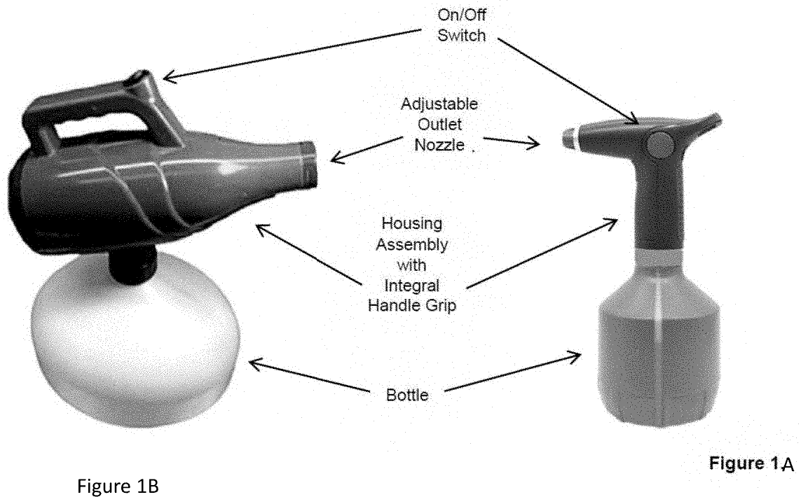

FIGS. 2A and 2B are illustrating relative functional impact of pump pressure on the effective spray mist application distance in a prior art sprayer.

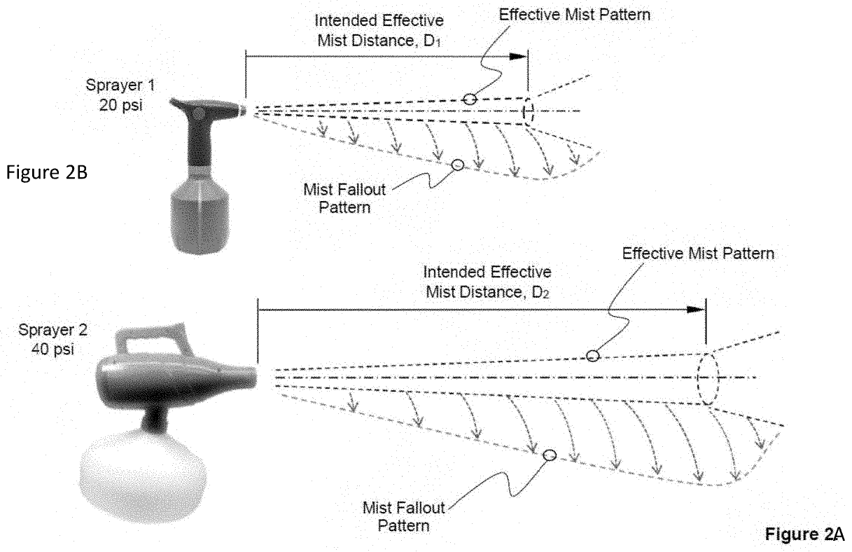

FIG. 3 is illustrating a prior art sprayer having an axial air fan blower.

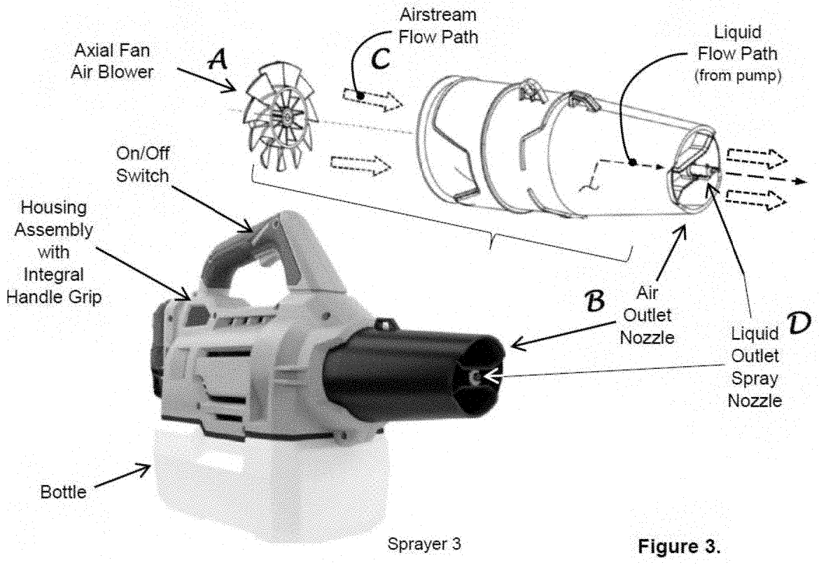

FIG. 4 is illustrating the intended spray mist distance of the prior art sprayer of FIG. 3.

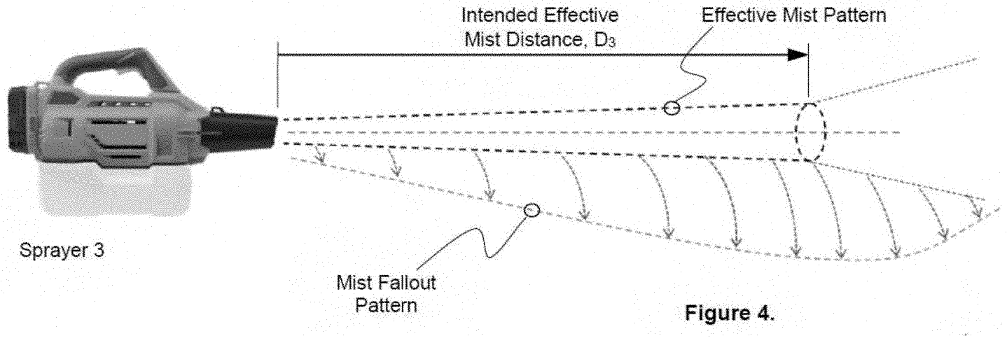

FIGS. 5A and 5B illustrate alternative configuration of a prior art liquid pump sprayer.

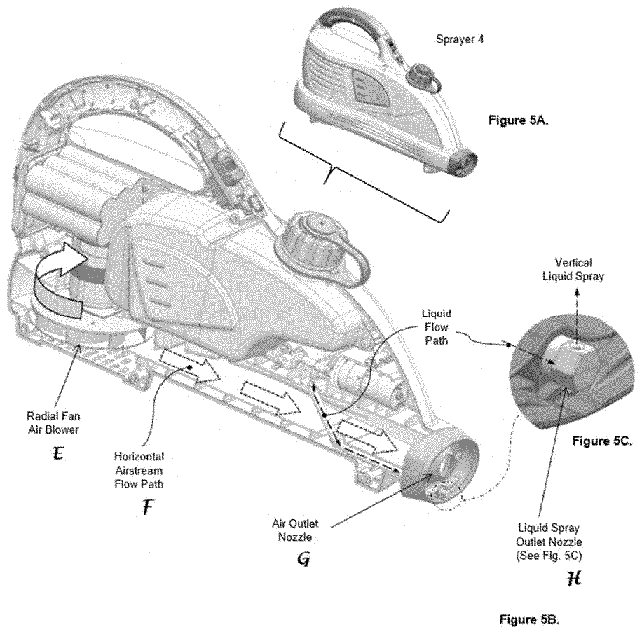

FIGS. 6A and 6B illustrate how the horizontally-directed airstream flow path is employed to intersect with and shear the vertically-oriented liquid spray, then propel the resulting liquid spray mist outward in the direction of the airstream in the prior art sprayer of FIGS. 5A and 5B.

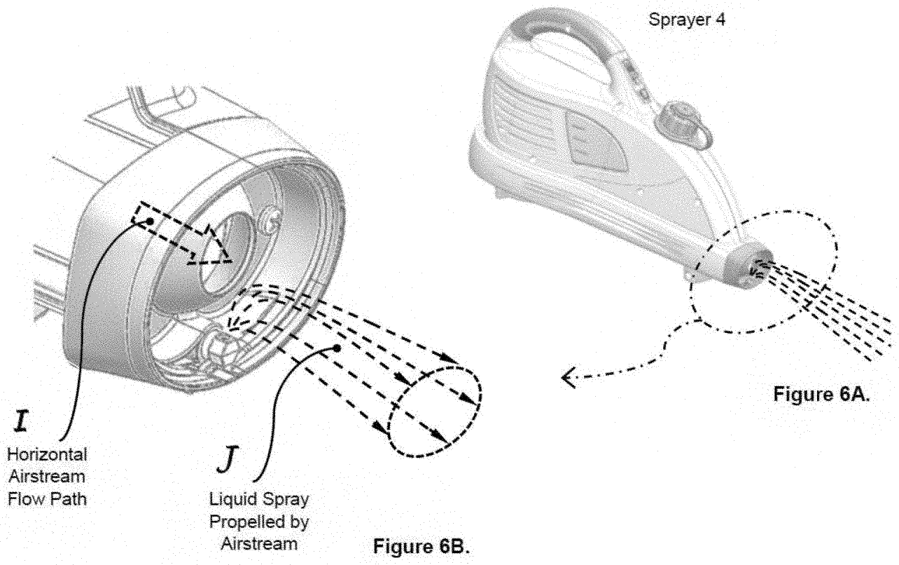

FIG. 7 illustrates the mist fallout for the prior art sprayer of FIGS. 5A and 5B.

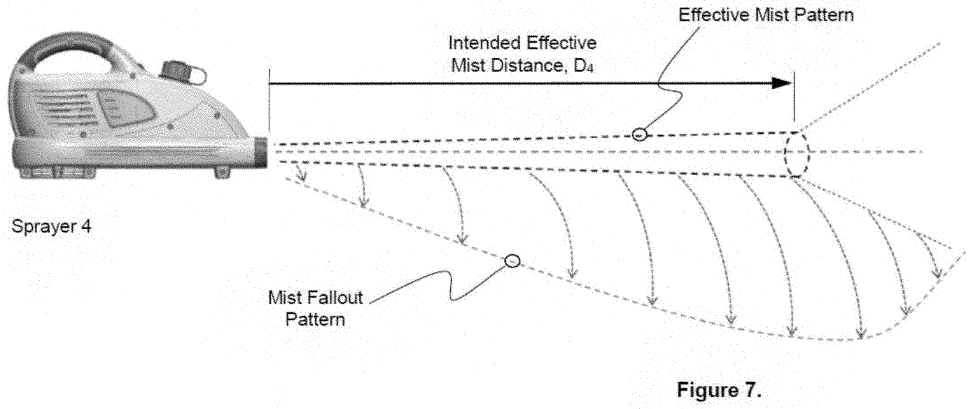

FIGS. 8A-8D illustrate exemplar sprayer configurations and example relative intended effective mist distances for the prior art sprayers of FIG.1 and FIG. 3 and FIGS. 5A and 5B.

FIG. 9 is a perspective view of a sprayer having a sprayer mist assist system, in accordance with an embodiment.

FIG. 10 is a cross-sectional view of the sprayer, in accordance with an embodiment.

FIG. 11 is a cross-sectional view of the sprayer showing the pressurized liquid flow path from pump to outlet nozzle and resulting spray mist pattern, in accordance with an embodiment.

FIG. 12 is a cross-sectional view of the sprayer showing the parallel orientation and offset spacing of the blower air outlet nozzle with respect to the spray mist nozzle, in accordance with an embodiment.

FIG. 13 is a cross-sectional view of the sprayer showing a 5-degree offset orientation of the blower air outlet nozzle with respect to the spray mist nozzle, in accordance with an embodiment.

FIGS. 14A-14C are each a side elevation view of the sprayer collectively showing the utility of the spray mist assist system, in accordance with an embodiment.

### DETAILED DESCRIPTION OF EMBODIMENTS

The present disclosure describes a spray mist assist sprayer/system 10 comprising an auxiliary radial air fan 12 with a uniquely positioned, oriented, and shaped blower air outlet nozzle 14. This mist assist system, in combination with the high pressure liquid pump, reduces the ineffective spray mist fallout and thusly improves spraying efficiency, especially when misting for mosquito control. Sprayer 10 includes the conventional elements such as a fluid reservoir 100 (from which liquid to be sprayed is drawn), a user handle 200, and power supplies, such as a battery 300 to provide the necessary power to drive sprayer 10, a switch 400 to control the level of liquid flow, and an on/off switch 500.

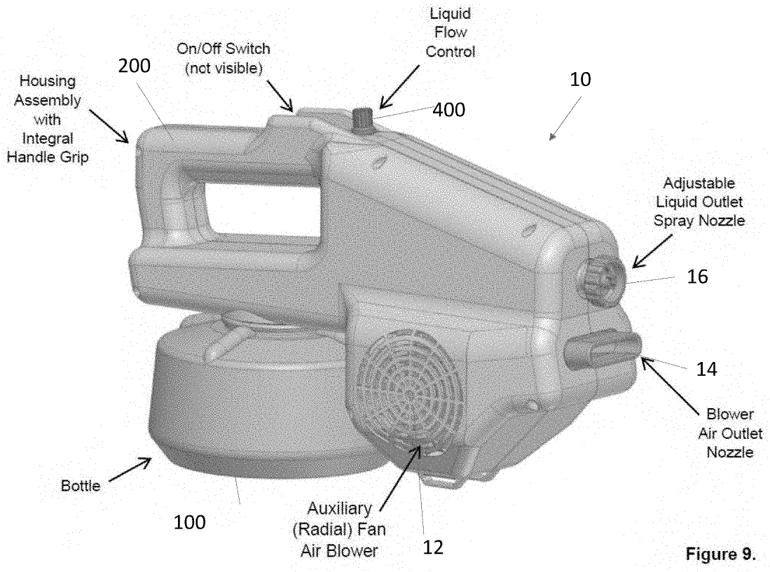

The basic layout of this spray mist assist system/sprayer 10 is illustrated in FIG. 9. Note that this sprayer 10 comprises the same basic componentry of the previously-described conventional liquid pump sprayer with auxiliary fan air blower 12.

Here, unlike the typical blower air outlet nozzle of Sprayer 3 that is positioned centrally around and in line with the liquid outlet spray nozzle, or the blower air outlet nozzle of Sprayer 4 that is positioned above the vertically-oriented liquid outlet spray nozzle, the blower air outlet nozzle 14 is uniquely shaped and beneficially oriented and positioned at an offset below the liquid outlet spray nozzle 16.

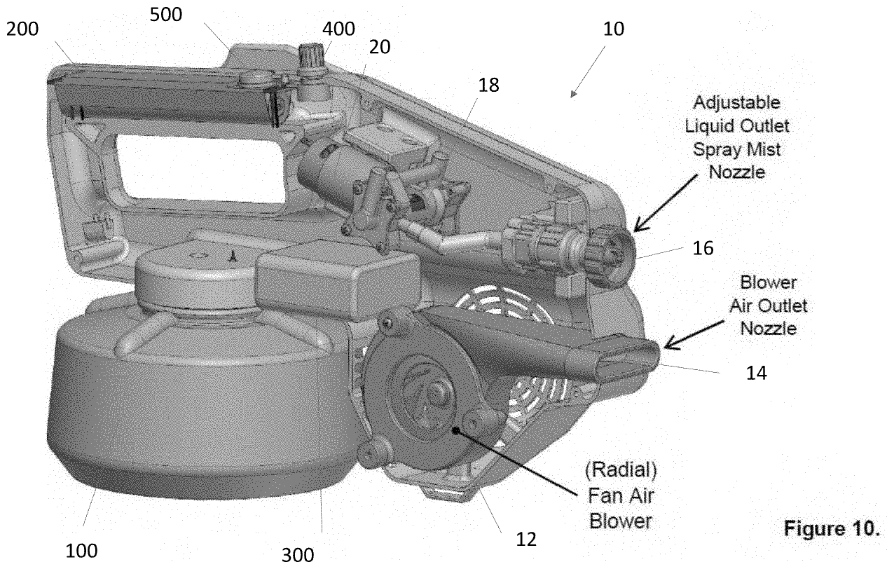

FIG. 10 illustrates the components that comprise the mist assist system: fan air blower 12, air outlet nozzle 14 and liquid spray mist nozzle 16. Note the elongated width shape of the air outlet nozzle 14.

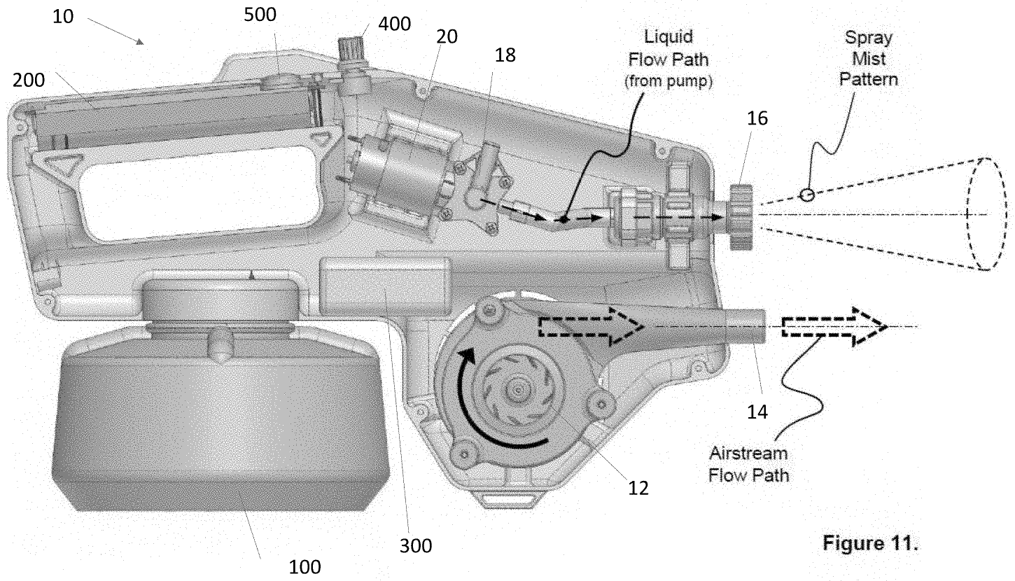

FIG. 11 shows the pressurized liquid flow path from pump 18 (powered by motor 20) to outlet nozzle 16 and resulting spray mist pattern, and the beneficial airstream flow path produced by the air blower 12.

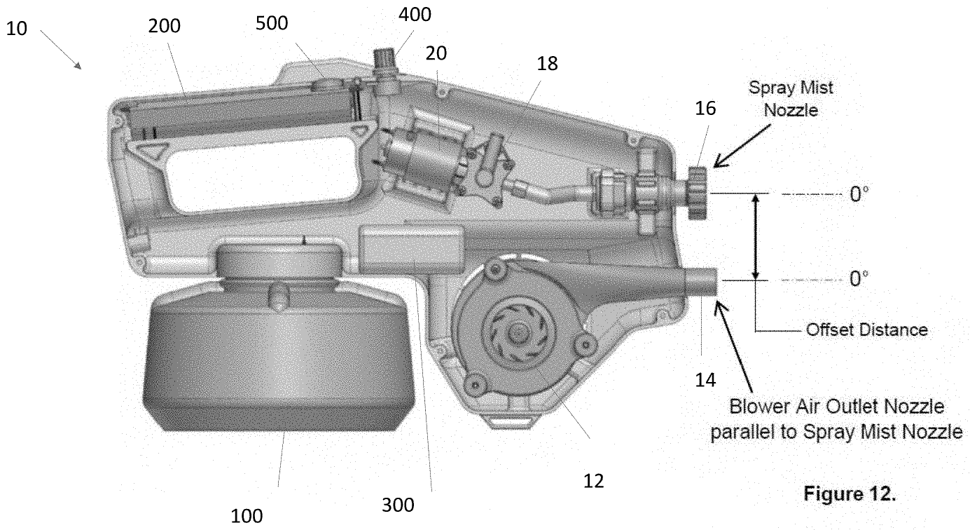

FIG. 12 discloses the preferred parallel orientation and vertically offset spacing of the blower air outlet nozzle 14 with respect to the spray mist nozzle 16. Other angular orientations of the air outlet nozzle are possible.

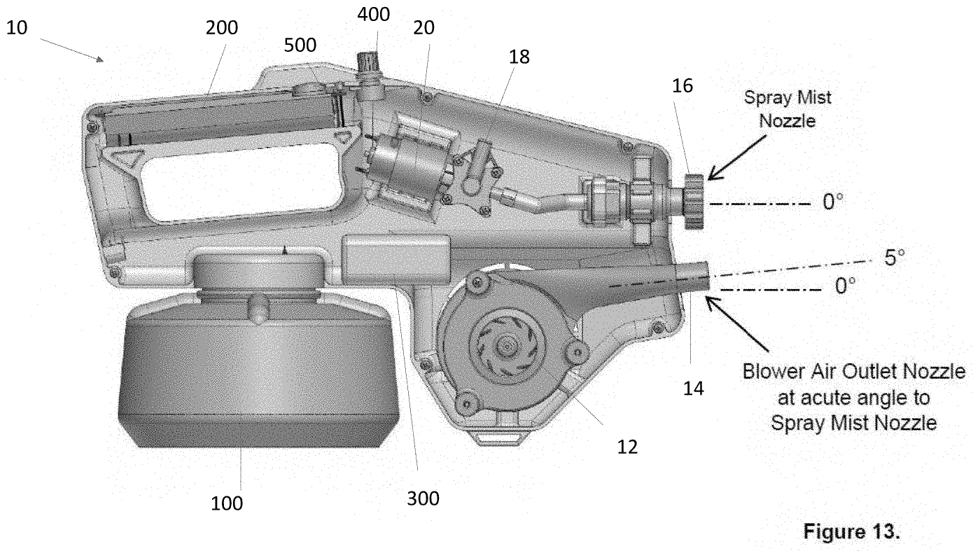

FIG. 13 shows an alternate 5-degree offset orientation of the blower air outlet nozzle 14 with respect to the spray mist nozzle 16. Other angular orientations of the air outlet nozzle are possible. The blower 12 can be selectively pivotal to adjust the direction of the air flow towards or away from the direction the spray mist nozzle emits liquid.

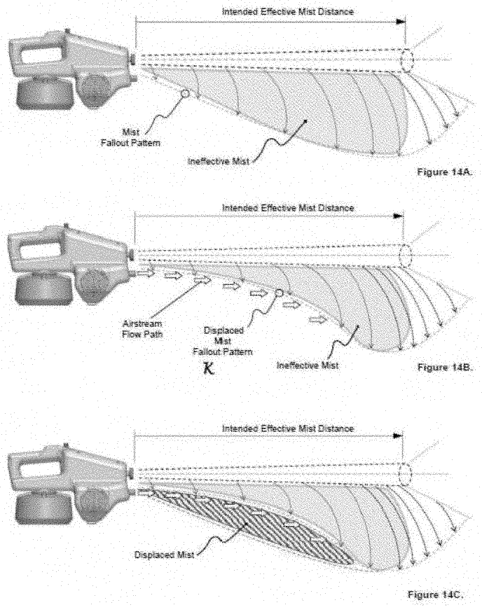

FIGS. 14A-C illustrate the utility and effectiveness of the spray mist assist system.

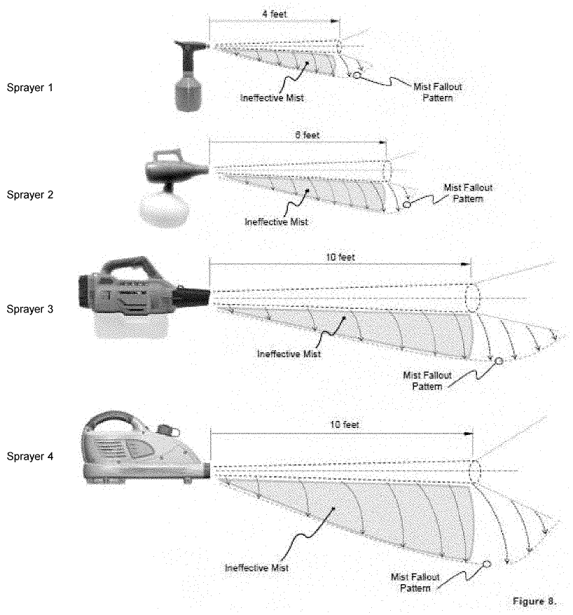

FIG. 14A shows the disclosed mist sprayer in operation, but with the mist assist system air blower disabled. As would be typical of any misting sprayer without benefit of the spray mist assist system (as previously described, and summarized in FIG. 8), a characteristic mist fallout pattern and concomitant ineffective mist is produced.

FIG. 14B shows the disclosed mist sprayer, now fully operating with the mist assist system air blower enabled. The air outlet nozzle, beneficially oriented and positioned at an offset location below the liquid spray mist nozzle, uniquely forms and directs an airstream flow path that reshapes the mist fallout pattern. As indicated, a now-displaced mist fallout pattern (note K) is established, such that the ineffective mist is displaced away from the sprayer and closer to the intended effective mist distance. In this way the overall mist spraying efficiency is increased as, for example when applying insecticide for mosquito control, less mist is lost due to fallout before the intended effective mist distance is reached.

FIG. 14C further illustrates this improved efficiency of the disclosed spray mist assist system. Shown here schematically is the volume of displaced mist that would otherwise fall to the ground before reaching the intended effective mean distance.

While mist fallout cannot be completely eliminated, the efficiency and effectiveness of misting applications is markedly improved by the application of this unique spray mist assist system to a liquid pump sprayer.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A sprayer for spraying a liquid, comprising:
a. a nozzle through which the liquid can be expelled in a first direction away from the sprayer;
b. a fan positioned in vertical alignment with and axially below the nozzle and for generating an air flow in a second direction that is parallel to the first direction; and
c. a fan outlet positioned in the path of the air flow and from which the air is expelled away from the sprayer.

2. The sprayer according to claim 1, wherein the fan outlet is selectively pivotal about the second direction to selectively adjust the direction of the expelled air flow towards or away from the first direction.

3. The sprayer for spraying a liquid, comprising:
a. a sprayer housing;
b. a nozzle connected to the sprayer housing and through which the liquid can be expelled in a first direction away from the sprayer;
c. a fan positioned within the sprayer housing and including a fan outlet that extends outside the sprayer housing and is positioned in axially spaced relation below the nozzle; and
d. wherein the fan is mounted within the sprayer housing for selective pivotal movement that causes movement of the fan outlet towards or away from the nozzle.
